(19) United States
(12) Patent Application Publication
(10) Pub. No.: US 2026/0004556 A1
(43) Pub. Date: Jan. 1, 2026

(54) DEGREE-OF-SIMILARITY CALCULATION SYSTEM, DEGREE-OF-SIMILARITY CALCULATION METHOD, AND STORAGE MEDIUM

(71) Applicant: TOYOTA JIDOSHA KABUSHIKI KAISHA, Toyota-shi (JP)

(72) Inventors: Yuichiro SUMI, Toyota-shi (JP); Yasuo KATSUHARA, Shizuoka-ken (JP); Eiji MITSUDA, Nagoya-shi (JP); Koji NISHIGUCHI, Osaka (JP); Soma WADA, Nagoya-shi (JP)

(73) Assignee: TOYOTA JIDOSHA KABUSHIKI KAISHA, Toyota-shi (JP)

(21) Appl. No.: 19/037,426

(22) Filed: Jan. 27, 2025

(30) Foreign Application Priority Data
Jun. 26, 2024 (JP) 2024-102639

(51) Int. Cl. G06V 10/74

(52) U.S. Cl. CPC G06V 10/761

(57) ABSTRACT

A plurality of evaluation items for evaluating similarity between a plurality of evaluation targets is set for each of the evaluation targets, and an attribute value is set for each of the evaluation items of each of the evaluation targets. The attribute value indicates a degree of an attribute of each of the evaluation targets for each of the evaluation items. A degree-of-similarity calculation system includes: an evaluation information acquisition unit configured to acquire information on attribute values of each evaluation item of each evaluation target; and a degree-of-similarity calculation unit configured to calculate a degree of similarity between evaluation targets based on attribute values of the evaluation items selected by the user or corresponding to the preference of the user.

### CROSS-REFERENCE TO RELATED APPLICATION

This application claims priority to Japanese Patent Application No. 2024-102639 filed on Jun. 26, 2024, incorporated herein by reference in its entirety.

### BACKGROUND

### 1. Technical Field

The present disclosure relates to degree-of-similarity calculation systems, degree-of-similarity calculation methods, and storage media.

### 2. Description of Related Art

A system that calculates the degree of similarity between a plurality of evaluation targets is known in the art (see, for example, Japanese Unexamined Patent Application Publication No. 2020-086692 (JP 2020-086692 A)).

### SUMMARY

When calculating the degree of similarity between a plurality of evaluation targets, the degree of similarity may be greatly affected by, and vary with, subjectivity of a user who carries out evaluation. However, the above system cannot be said to sufficiently reflect the subjectivity of the user in calculation of the degree of similarity between the evaluation targets.

The present disclosure was made to solve such an issue, and a primary object of the present disclosure is to provide a degree-of-similarity calculation system, degree-of-similarity calculation method, and storage medium storing a program that can calculate such a degree of similarity between evaluation targets that reflects subjectivity of a user.

One aspect of the present disclosure for achieving the above object is a degree-of-similarity calculation system.

A plurality of evaluation items for evaluating similarity between a plurality of evaluation targets is set for each of the evaluation targets.

An attribute value is set for each of the evaluation items of each of the evaluation targets. The attribute value indicates a degree of an attribute of each of the evaluation targets for each of the evaluation items.

The degree-of-similarity calculation system includes:
an evaluation information acquisition unit configured to acquire information on the attribute value of each of the evaluation items of each of the evaluation targets; and
a degree-of-similarity calculation unit configured to calculate a degree of similarity between the evaluation targets based on the attribute value of the evaluation item selected by a user or corresponding to a preference of the user.

In the above aspect, the degree-of-similarity calculation system may further include a preference information acquisition unit configured to acquire preference information of the user.

The degree-of-similarity calculation unit may be configured to select the evaluation item based on the preference information of the user acquired by the preference information acquisition unit and calculate the degree of similarity between the evaluation targets based on the attribute value of the selected evaluation item.

In the above aspect, the degree-of-similarity calculation system may further include a selected item acquisition unit configured to acquire information on the evaluation item selected by the user.

The degree-of-similarity calculation unit may be configured to calculate the degree of similarity between the evaluation targets based on the attribute value of the evaluation item acquired by the selected item acquisition unit.

Another aspect of the present disclosure for achieving the above object is a degree-of-similarity calculation method.

A plurality of evaluation items for evaluating similarity between a plurality of evaluation targets is set for each of the evaluation targets.

An attribute value is set for each of the evaluation items of each of the evaluation targets.

The attribute value indicates a degree of an attribute of each of the evaluation targets for each of the evaluation items.

The degree-of-similarity calculation method includes:
acquiring information on the attribute value of each of the evaluation items of each of the evaluation targets; and
calculating a degree of similarity between the evaluation targets based on the attribute value of the evaluation item selected by a user or corresponding to a preference of the user.

Still another aspect of the present disclosure for achieving the above object is a storage medium storing a program.

A plurality of evaluation items for evaluating similarity between a plurality of evaluation targets is set for each of the evaluation targets.

An attribute value is set for each of the evaluation items of each of the evaluation targets.

The attribute value indicates a degree of an attribute of each of the evaluation targets for each of the evaluation items.

The program causes a computer to perform
acquiring information on the attribute value of each of the evaluation items of each of the evaluation targets, and
calculating a degree of similarity between the evaluation targets based on the attribute value of the evaluation item selected by a user or corresponding to a preference of the user.

The present disclosure can provide a degree-of-similarity calculation system, degree-of-similarity calculation method, and storage medium storing a program that can calculate such a degree of similarity between evaluation targets that reflects subjectivity of a user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic system configuration of a degree-of-similarity calculation system according to the present embodiment;

FIG. 2 is a diagram illustrating an example of attribute value information;

FIG. 3A is a diagram illustrating a degree-of-similarity calculation method according to the embodiment;

FIG. 3B is a diagram illustrating the degree-of-similarity calculation method according to the embodiment;

FIG. 4 is a flowchart illustrating an example of a flow of the degree-of-similarity calculation method according to the embodiment;

FIG. 5 is a diagram illustrating a schematic system configuration of the degree-of-similarity calculation system according to the embodiment; and

FIG. 6 is a block diagram illustrating a schematic system configuration of a recommendation system according to the embodiment.

### DETAILED DESCRIPTION OF EMBODIMENTS

### First Embodiment

Hereinafter, the present embodiment will be described with reference to the drawings. For example, when calculating the degree of similarity between evaluation targets such as a plurality of items, the degree of similarity may be greatly affected by, and vary with, the subjectivity (preference) of the user who performs the evaluation.

On the other hand, the degree-of-similarity calculation system according to the present embodiment calculates the degree of similarity between a plurality of evaluation targets by sufficiently reflecting the subjectivity of the user. The evaluation target is, for example, a commodity, a sentence, a word, an image including a still image and a moving image, a sound, a tourist spot, or the like.

Note that the degree-of-similarity calculation system according to the present embodiment has a hardware configuration of an ordinary computer including, for example, a processor such as CPU (Central Processing Unit) or GPU (Graphics Processing Unit), an internal memory such as RAM (Random Access Memory) or ROM (Read Only Memory), a storage device such as HDD (Hard Disk Drive) or SSD (Solid State Drive), an input and output I/F for connecting a peripheral device such as a display, and a communication I/F 15 for communicating with an external device.

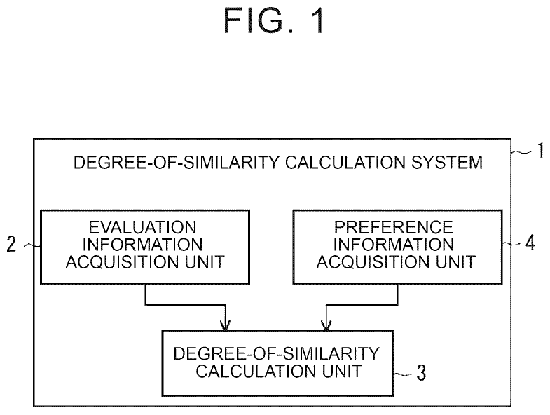

FIG. 1 is a block diagram illustrating a schematic system configuration of a degree-of-similarity calculation system according to the present embodiment. The degree-of-similarity calculation system 1 according to the present embodiment includes an evaluation information acquisition unit 2 that acquires information on attribute values of evaluation items, a degree-of-similarity calculation unit 3 that calculates the degree of similarity between evaluation targets, and a preference information acquisition unit 4 that acquires preference information of a user.

A plurality of evaluation items for evaluating similarity between the evaluation targets is set for each of the plurality of evaluation targets. An attribute value is set for each evaluation item of each evaluation target. The attribute value indicates the degree of an attribute of each evaluation target for each evaluation item. When the degree of the attribute of the evaluation target for the evaluation item is high, the attribute value is large. On the other hand, when the degree of the attribute of the evaluation target for the evaluation item is low, the attribute value is small.

The evaluation information acquisition unit 2 is a specific example of an evaluation information acquisition unit. The evaluation information acquisition unit 2 acquires information on attribute values (hereinafter, referred to as attribute value information) of each evaluation item of each evaluation target.

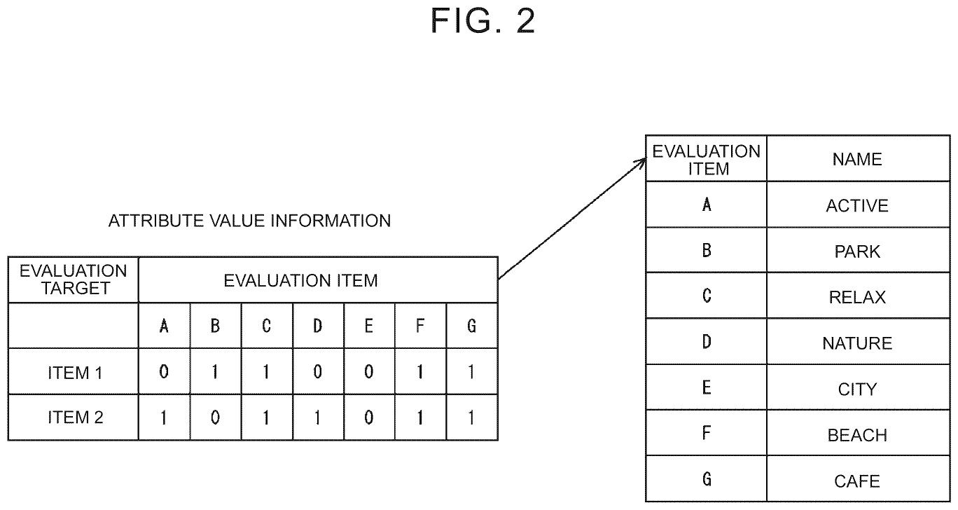

FIG. 2 is a diagram illustrating an example of attribute value information. The attribute value information may be configured as table information as shown in FIG. 2. For example, as shown in FIG. 2, the evaluation targets are items 1 and 2, and the evaluation items are A (active), B (park), C (relaxed), D (natural), E (urban), F (beach), and G (cafe). The attribute value is a flag value represented by 0 or 1.

For example, when the item is an image and the evaluation item is B (park), if the image includes a park, the attribute value is set to 1, and if the image does not include a park, the attribute value is set to 0. Note that not only two values of 0 and 1 but also decimal values such as 0.1 to 0.9 or stepped values such as 0 to 10 may be set as the attribute value.

More specifically, when the evaluation item is F (beach), if the image includes a sea, the attribute value is set to 1, whereas if the image includes a river, the attribute value is set to 0.5, and if the image includes a mountain, the attribute value is set to 0.1. This is because, for the evaluation item F (beach), the degree of the attribute of the sea is the highest, the degree of the attribute of the river is not so high, and the degree of attribute of the mountain is low.

The attribute value information may be stored in advance in a storage unit such as a storage device. The evaluation information acquisition unit 2 may acquire attribute value information from a storage device etc., or may acquire information on the web (World Wide Web) via the Internet etc.

For example, the evaluation information acquisition unit 2 may acquire, via the Internet or the like, a hashtag used in a web service or the like, a tag assigned to a product on an online shopping site or the like, and set the acquired tag or the like as an evaluation item. Further, the user may input and set the evaluation information acquisition unit 2 via an input device or the like.

The evaluation information acquisition unit 2 may generate attribute value information by generating an evaluation item and an attribute value using a machine learning device such as a neural network. For example, when the evaluation target is an image, the evaluation information acquisition unit 2 may input an image to the machine learning device, automatically set evaluation items such as “relaxation” and “natural”, and automatically assign the attribute values.

The degree-of-similarity calculation unit 3 is a specific example of a degree-of-similarity calculation unit. The degree-of-similarity calculation unit 3 calculates the degree of similarity between evaluation targets based on the attribute value information acquired by the evaluation information acquisition unit 2.

When calculating the degree of similarity between a plurality of evaluation targets, the degree of similarity may be greatly affected by, and vary with, the subjectivity of the user who performs evaluation.

On the other hand, the degree-of-similarity calculation unit 3 according to the present embodiment calculates the degree of similarity between the evaluation targets by reflecting the subjectivity of the user in the evaluation of the degree of similarity between the evaluation targets. Accordingly, it is possible to calculate the degree of similarity between evaluation targets reflecting the subjectivity of the user.

The preference information acquisition unit 4 is a specific example of a preference information acquisition unit. The preference information acquisition unit 4 acquires preference information of the user. The preference information is information indicating a preference of the user, and is information such as a hobby, a color of the preference, a shape of the preference, a favorite place, and the like.

The preference information may include browsing history information when the user views the web, action history information when the user acts on the web, search history information when the user performs a search on the web, click history information when the user clicks on the web, and purchasing history information when the user purchases a product etc. on the web.

The preference information of the user may be stored in a storage unit such as a storage device in advance, for example. The preference information acquisition unit 4 can acquire preference information from a storage device or the like. Alternatively, the user may input the preference information to the preference information acquisition unit 4 via an input device or the like.

The degree-of-similarity calculation unit 3 selects at least one evaluation item corresponding to the user's preference from the plurality of evaluation items set in the attribute value information based on the preference information acquired by the preference information acquisition unit 4. The degree-of-similarity calculation unit 3 may select, for example, an evaluation item having a high degree of correlation with the preference information and a high degree of association among a plurality of evaluation items of the attribute value information.

The degree-of-similarity calculation unit 3 may select, for example, an evaluation item corresponding to an object (such as a product) included in the browsing history information of the preference information, the action history information, the search history information, or the purchase history information from among a plurality of evaluation items of the attribute value information. The term “corresponding to a product” refers to, for example, an evaluation item that is the same as the product or an evaluation item that has high relevance to the product.

The degree-of-similarity calculation unit 3 may select, from among the plurality of evaluation items of the attribute value information, an evaluation item corresponding to an object having the number of times of browsing, the number of times of searching, and the number of times of purchasing equal to or more than a predetermined value, based on, for example, the browsing history information and the search history information of the preference information.

The degree-of-similarity calculation unit 3 may calculate the degree of similarity between evaluation targets based on only the attribute values of the selected evaluation items. As a result, the degree of similarity between the evaluation targets can be calculated using only the attribute values of the evaluation items related to the preference of the user, so that the degree of similarity between the evaluation targets reflecting the subjectivity of the user can be calculated.

The degree-of-similarity calculation unit 3 may calculate the degree of similarity between evaluation targets by increasing the weighting of only the attribute values of the selected evaluation items. The degree-of-similarity calculation unit 3 may increase the weighting factor by, for example, setting the weighting factor for the weighting larger than 1 (weighting factor >1). As a result, it is possible to calculate the degree of similarity between the evaluation targets reflecting the subjectivity of the user by weighting and emphasizing only the attribute values of the evaluation items related to the preference of the user.

The degree-of-similarity calculation unit 3 may calculate the degree of similarity between evaluation targets by lowering the weighting of the attribute values other than the selected evaluation item. Furthermore, the degree-of-similarity calculation unit 3 may calculate the degree of similarity between the evaluation targets by increasing the weighting of the attribute values for the evaluation items having a higher correlation degree and a higher degree of association with the preference information. Further, for example, the user may prioritize the evaluation items, and the degree-of-similarity calculation unit 3 may increase the weighting of the attribute values of the evaluation items as the priority of the evaluation items increases.

The preference of the user is influenced by the current trend. Therefore, the degree-of-similarity calculation unit 3 may select at least one evaluation item from the plurality of evaluation items set in the attribute value information based on not only the preference information acquired by the preference information acquisition unit 4 but also the information on the currently popular object (trend information).

As a result, it is possible to narrow down to evaluation items that more appropriately reflect the preference of the user. For example, the degree-of-similarity calculation unit 3 may acquire the trend information from the web. For example, the degree-of-similarity calculation unit 3 may select, from among the plurality of evaluation items of the attribute value information, an evaluation item having a high degree of correlation and a high degree of association with the preference information and included in the trend information.

Further, the degree-of-similarity calculation unit 3 may select at least one evaluation item from a plurality of evaluation items set in the attribute value information on the basis of preference information corresponding to the attribute (male, female, age group, hobby, occupation, etc.) to which the user belongs. In this case, a database in which preference information is associated with each attribute may be constructed in advance.

The degree-of-similarity calculation unit 3 calculates the degree of similarity between evaluation targets, for example, by calculating the cosine similarity, Euclidean distance, etc. between the evaluation targets based on the attribute value of the selected evaluation item as described above.

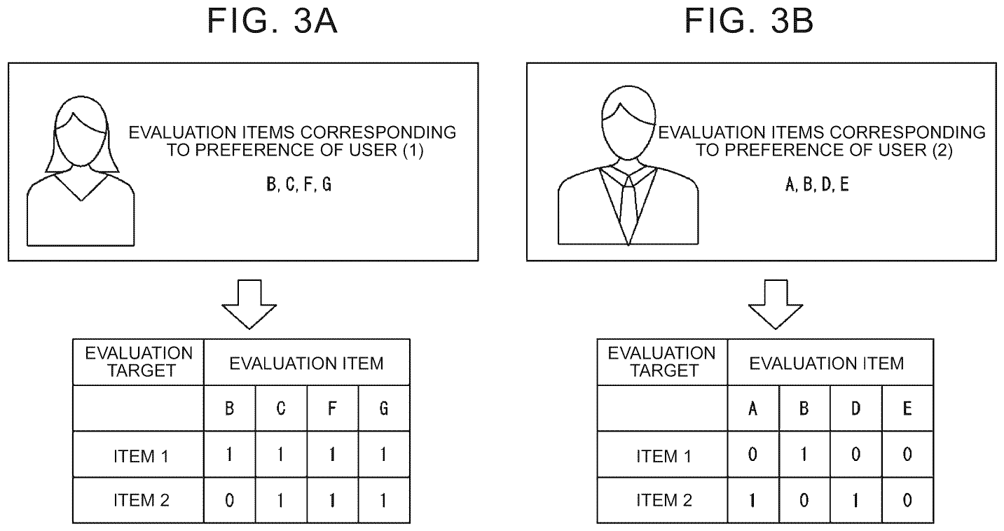

Here, a specific embodiment of the degree-of-similarity calculation method according to the present embodiment will be described referring to FIGS. 2, 3A, and 3B. For example, the degree-of-similarity calculation system 1 calculates the degree of similarity between the items 1 and 2 as follows. First, the evaluation information acquisition unit 2 acquires the attribute value information of the items 1 and 2 as shown in FIG. 2. The preference information acquisition unit 4 acquires preference information of the users (1) and (2).

Based on the preference information of the user (1) acquired by the preference information acquisition unit 4, the degree-of-similarity calculation unit 3 selects the evaluation items B, C, F, and G that are highly correlated with the preference of the user (1) from the plurality of evaluation items A to G set in the attribute value information. As shown in FIG. 3A, the degree-of-similarity calculation unit 3 calculates the degree of similarity (for example, 0.75) between the items 1 and 2 based on the attribute values of the evaluation items B, C, F, and G.

In this case, when the subjectivity of the user (1) is reflected in evaluation of the degree of similarity, the degree of similarity between the items 1 and 2 is high, and the items 1 and 2 are evaluated to be similar.

On the other hand, the degree-of-similarity calculation unit 3 selects the evaluation items A, B, D, and E corresponding to the preference of the user (2) from the plurality of evaluation items A to G set in the attribute value information, based on the preference information of the user (2) acquired by the preference information acquisition unit 4. As shown in FIG. 3B, the degree-of-similarity calculation unit 3 calculates the degree of similarity (for example, 0) between the items 1 and 2 based on the attribute values of the evaluation items A, B, D, and E. In this case, when the subjectivity of the user (2) is reflected in evaluation of the degree of similarity, the degree of similarity between the items 1 and 2 is low, and the items 1 and 2 are evaluated to be not similar.

That is, the evaluation of the degree of similarity varies depending on the subjectivity of the users (1) and (2). According to the present embodiment, an appropriate degree of similarity according to the subjectivity of the users (1) and (2) can be calculated.

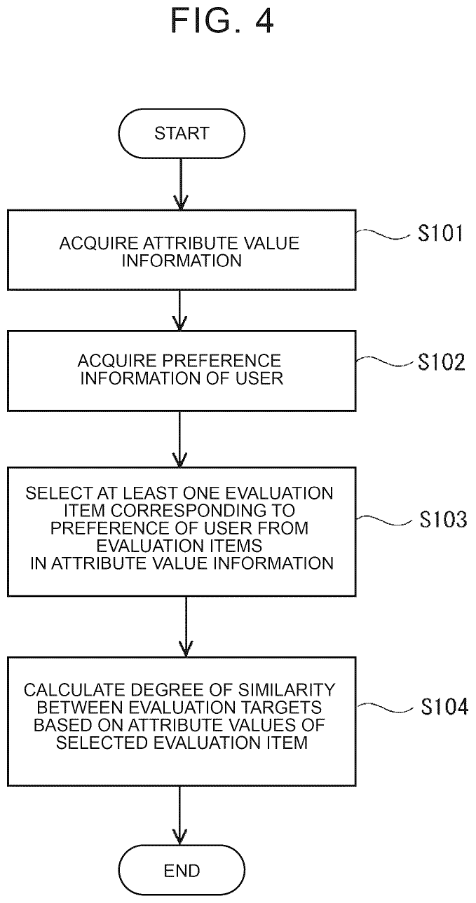

Next, a degree-of-similarity calculation method according to the present embodiment will be described. FIG. 4 is a flowchart showing an example of a flow of the degree-of-similarity calculation method according to the present embodiment.

The evaluation information acquisition unit 2 acquires attribute value information (S101). The preference information acquisition unit 4 acquires preference information of the user (S102).

Based on the preference information acquired by the preference information acquisition unit 4, the degree-of-similarity calculation unit 3 selects at least one evaluation item corresponding to the preference of the user from the plurality of evaluation items set in the attribute value information (S103).

The degree-of-similarity calculation unit 3 calculates the degree of similarity between the evaluation targets based on the attribute values of the selected evaluation items (S104).

As described above, according to the degree-of-similarity calculation method of the present embodiment, it is possible to calculate the degree of similarity between evaluation targets reflecting the preference of the user.

### Second Embodiment

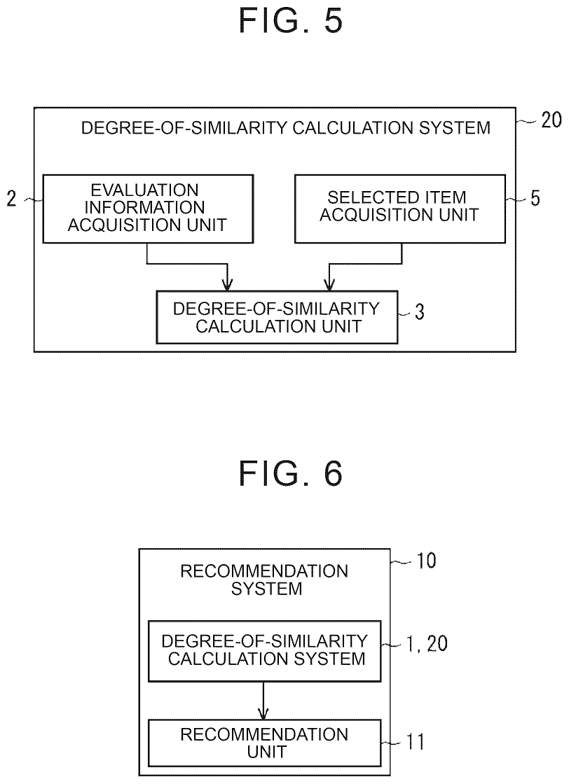

FIG. 5 is a block diagram showing illustrating a schematic system configuration of the degree-of-similarity calculation system according to the present embodiment. The degree-of-similarity calculation system 20 according to the present embodiment may include, instead of the preference information acquisition unit 4, a selection item acquisition unit 5 that acquires information on an evaluation item selected by a user (hereinafter, selected evaluation item information). The selection item acquisition unit 5 is a specific example of the selected item acquisition unit.

Since the selected evaluation item information includes the evaluation item selected by the user himself/herself, the user's subjectivity is reflected. Therefore, as will be described later, by calculating the degree of similarity between the evaluation targets using the selected evaluation item information, it is possible to calculate such a degree of similarity between the evaluation targets that reflects the subjectivity of the user.

The selected evaluation item information may be stored in advance in a storage unit such as a storage device. The evaluation information acquisition unit 2 can acquire the selected evaluation item information from a storage device or the like. Alternatively, the user may input the evaluation information acquisition unit 2 via an input device or the like.

The degree-of-similarity calculation unit 3 calculates the degree of similarity between evaluation targets based on the attribute values of the evaluation items included in the selection evaluation item information acquired by the selection item acquisition unit 5.

Note that the degree-of-similarity calculation unit 3 may calculate the degree of similarity between evaluation targets by weighting only the attribute values of the evaluation items included in the selection evaluation item information acquired by the selection item acquisition unit 5. As described above, by weighting and emphasizing only the attribute value of the evaluation item selected by the user himself/herself, it is possible to calculate the degree of similarity between the evaluation targets reflecting the subjectivity of the user.

### Third Embodiment

FIG. 6 is a block diagram showing a schematic system configuration of the recommendation system according to the present embodiment. The recommendation system 10 according to the present embodiment recommends, for example, an item corresponding to a user's preference to the user.

The recommendation system 10 according to the present embodiment includes the degree-of-similarity calculation system 1, 20 described above, and a recommendation unit 11 that recommends an item. The recommendation unit 11 recommends to the user an item whose degree of similarity calculated by the degree-of-similarity calculation system is equal to or higher than a predetermined value.

Users tend to seek items similar to items viewed in the past. For example, the item 1 in FIG. 2 is an item viewed by the user in the past, and the item 2 is a recommendation candidate item.

As described above, the degree-of-similarity calculation unit 3 selects the evaluation item of the attribute value information based on the preference information of the user or the like, and calculates the degree of similarity between the items 1 and 2 based on the attribute value of the selected evaluation item. When determining that the degree of similarity between the items 1 and 2 is equal to or greater than a predetermined value and that the items 1 and 2 are similar, the recommendation unit 11 recommends the item 2 to the user.

In a case where the degree of similarity between the items 1 and 2 is less than the predetermined value and the items 1 and 2 are not similar, the degree-of-similarity calculation unit 3 may repeat the calculation of the degree of similarity until an item similar to the item 1 is found. In this case, the attribute value information may include information on the attribute values of the evaluation items of items 1, 2, 3, . . . , n.

For example, the recommendation unit 11 may make a recommendation to the user by causing the item 2 determined to be similar to the item 1 to be displayed on a screen of a mobile terminal such as a smartphone as an advertisement or a recommended product.

While certain embodiments have been described, these embodiments have been presented by way of example only, and are not intended to limit the scope of the disclosure. These novel embodiments can be embodied in various other modes, and various omissions, replacements, and modifications can be made without departing from the scope of the disclosure. These embodiments and modifications thereof are included in the scope and gist of the disclosure and are included in the scope of the disclosure described in the claims and equivalents thereof.

For example, the present disclosure can be implemented by causing a processor to execute a computer program in the processing shown in FIG. 4.

The program can be stored and provided to the computer using various types of non-transitory computer-readable media (storage media). Non-transitory computer-readable media include various types of tangible recording media (tangible storage media). Exemplary non-transitory computer-readable media include magnetic recording media (e.g., flexible disks, magnetic tapes, hard disk drives), magneto-optical recording media (e.g., magneto-optical disks), CD-ROM (Read Only Memory), CD-R, CD-R/W, solid-state memories (e.g., mask ROM, PROM (Programmable ROM), EPROM (Erasable PROM), flash ROM, RAM (random access memory).

The program may be provided to the computer by various types of transitory computer-readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

The units constituting the degree-of-similarity calculation system 1, 20 according to the above embodiments may not be implemented by a program. Part or all of the units constituting the degree-of-similarity calculation system 1, 20 may be implemented by dedicated hardware such as ASIC (Application Specific Integrated Circuit) or FPGA (Field-Programmable Gate Array).

What is claimed is:

1. A degree-of-similarity calculation system, wherein
a plurality of evaluation items for evaluating similarity between a plurality of evaluation targets is set for each of the evaluation targets,
an attribute value is set for each of the evaluation items of each of the evaluation targets, the attribute value indicating a degree of an attribute of each of the evaluation targets for each of the evaluation items, and
the degree-of-similarity calculation system includes
an evaluation information acquisition unit configured to acquire information on the attribute value of each of the evaluation items of each of the evaluation targets, and
a degree-of-similarity calculation unit configured to calculate a degree of similarity between the evaluation targets based on the attribute value of the evaluation item selected by a user or corresponding to a preference of the user.

2. The degree-of-similarity calculation system according to claim 1, further comprising a preference information acquisition unit configured to acquire preference information of the user,
wherein the degree-of-similarity calculation unit is configured to select the evaluation item based on the preference information of the user acquired by the preference information acquisition unit and calculate the degree of similarity between the evaluation targets based on the attribute value of the selected evaluation item.

3. The degree-of-similarity calculation system according to claim 1, further comprising a selected item acquisition unit configured to acquire information on the evaluation item selected by the user,
wherein the degree-of-similarity calculation unit is configured to calculate the degree of similarity between the evaluation targets based on the attribute value of the evaluation item acquired by the selected item acquisition unit.

4. A degree-of-similarity calculation method, wherein
a plurality of evaluation items for evaluating similarity between a plurality of evaluation targets is set for each of the evaluation targets,
an attribute value is set for each of the evaluation items of each of the evaluation targets, the attribute value indicating a degree of an attribute of each of the evaluation targets for each of the evaluation items, and
the degree-of-similarity calculation method includes
acquiring information on the attribute value of each of the evaluation items of each of the evaluation targets, and
calculating a degree of similarity between the evaluation targets based on the attribute value of the evaluation item selected by a user or corresponding to a preference of the user.

5. A non-transitory storage medium storing a program, wherein
a plurality of evaluation items for evaluating similarity between a plurality of evaluation targets is set for each of the evaluation targets,
an attribute value is set for each of the evaluation items of each of the evaluation targets, the attribute value indicating a degree of an attribute of each of the evaluation targets for each of the evaluation items, and
the program causes a computer to perform
acquiring information on the attribute value of each of the evaluation items of each of the evaluation targets, and
calculating a degree of similarity between the evaluation targets based on the attribute value of the evaluation item selected by a user or corresponding to a preference of the user.
